(19) United States
(12) Patent Application Publication
(10) Pub. No.: US 2013/0319928 A1
(43) Pub. Date: Dec. 5, 2013

(54) Filter Candle and Cleaning Method and Device

(71) Applicant: Bucher Filtrox Systems AG, St. Gallen (CH)

(72) Inventor: Jürg Zuber, Uzwil (CH)

(21) Appl. No.: 13/899,158

(22) Filed: May 21, 2013

(30) Foreign Application Priority Data
Jun. 1, 2012 (EP) 12170475.3

(51) Int. Cl. B01D 29/00

(52) U.S. Cl. CPC B01D 29/0065
USPC 210/409; 210/440

(57) ABSTRACT

A filter candle for precoat filtration has an end piece for connecting the filter candle to a separating wall of a precoat candle filter, a candle wall which together with a precoated precoat layer forms the active filter layer, and a terminating piece for separating an interior candle space from an unfiltrate space. An immersion tube is arranged in the interior candle space and reaches from outside the end piece, through the separating wall and the end piece, into a lower end portion of the interior candle space. At least one opening is provided in the immersion tube within the lower end portion, and a gap is formed between the immersion tube and the end piece.

The present invention relates to a filter candle and to a cleaning device for precoat filtration, to a precoat candle filter, to the use of a filter candle, to a method for upgrading or retrofitting a filter system, to a method for operating a precoat candle filter and to a method for changing phases according to the preambles of the independent claims.

Various filter candles for precoat filtration and precoat candle filters are known from the prior art.

For example, EP0203206A1 shows a backflushable filter candle for precoat filtration which has a split tube. Arranged within a fastening tube, by which the filter candle can be fitted into a corresponding separating wall of a precoat filter, is a tube. This tube serves on the one hand for discharging the filtrate from the filter candle. On the other hand, the tube also serves for the backflushing or discarding of the filter cake. For this purpose, a flushing fluid is admitted into the interior space of the filter candle from the filtrate space through the tube, such that on the outside of the filter candle the filter cake adhering thereto is detached. For easier detachment of the filter cake, the tube is closed on its lower side and has lateral openings, which direct the flushing fluid radially onto the inner wall of the filter candle. It is disadvantageous that the filtrate in the interior space of the candles cannot be displaced when pressure is applied by a gaseous fluid for emptying purposes.

As a result, the filter cake cannot be completely dried or blown out; a gas blown in escapes in the upward direction. If the forward flow of the gas flow is not sustained, the liquid column remaining in the filter candle can detach the filter cake from the candle, such that it may be necessary for renewed precoating to be carried out again.

EP0155336A1 shows a filter candle which is provided with an immersion tube. This immersion tube protrudes almost as far as the lower end of the filter candle and is intended to ensure that no zone with stagnant medium where turbid matter could possibly be deposited forms in the interior candle space. This does allow the interior space of the filter candle to be largely emptied by way of the immersion tube at the end of the filtration by blowing in a gaseous fluid. However, during the subsequent refilling with product, an air bubble that has built up between the candle and the immersion tube can no longer escape, since the candle is already covered with a filter cake. This is particularly disadvantageous because the filtrate thus comes into contact with air or oxygen, which causes losses in quality. Furthermore, the blasting off of the filter cake at the end of the filtration is usually performed by means of a back surge of water. In order that this back surge can act on all the candles and at all points of the candles simultaneously, the filter candles must not have any air pockets. Such air pockets have a damping effect, such that a back surge of water only detaches the cake in the lower region of the filter candles.

It is the object of the invention to overcome the disadvantages of the prior art. In particular, it is intended to provide a filter candle that only holds back a small residual amount of filtrate and can be vented as completely as possible. Furthermore, it is intended to provide a precoat candle filter that makes it possible when changing phases, for example from water to beer, to obtain the least possible mixing of the phases.

This object is achieved by the devices and methods that are defined in the independent patent claims. Further embodiments are obtained from the dependent patent claims.

A filter candle according to the invention for precoat filtration, the filter candle being intended for suspended installation, has an end piece for the connection of the filter candle to a separating wall of a precoat candle filter. The end piece is in this case of a tubular or annular design and may be connected to a connection piece, which is arranged in the separating wall. Furthermore, the filter candle has a candle wall with an inside candle diameter and an outside candle diameter, the candle wall together with a precoated precoat layer forming the active filter layer. Furthermore, the filter candle has a terminating piece for separating an interior candle space from an unfiltrate space. An immersion tube is arranged in the interior candle space and, when used as intended, reaches from outside the end piece through the separating wall and the end piece into a lower end portion of the interior candle space. In this case, a lower end portion of the interior candle space is understood as meaning that region that is located within a distance from the terminating piece that is less than or equal to the outside candle diameter. At least one opening is provided in the immersion tube within this lower end portion. This opening is preferably of such a size that it corresponds approximately to the cross-sectional area of the bore of the immersion tube. The opening in the immersion tube may in this case be formed at the end of the immersion tube. Alternatively, one or more openings in the wall in the end region of the immersion tube are also conceivable. A gap is formed between the immersion tube and the end piece. This gap may thus be used for example for the venting of the filter candle or for the backflushing. It goes without saying that a gap is likewise formed between the immersion tube and the candle wall. Correspondingly, the outside diameter of the immersion tube is dimensioned to be smaller than the inside candle diameter and less than the inside diameter of the end piece and also less than the inside diameter of the connection piece. The inside diameters of the connection piece and of the end piece may in this case have the same dimension. The immersion tube preferably has a closed wall above the end portion.

The use of an immersion tube has the advantage that, when applying pressure to empty a filter or when blowing out a filter by means of a gaseous fluid, both the liquid from the filter vessel and the liquid in the filter cake are largely displaced. Correspondingly, after blowing out the filter, the precoat layer or the filter cake is almost dry and only contains a small remaining proportion of liquid.

The gap between the end piece or the connection piece and the immersion tube makes flushing of the interior candle space possible, such that the entire volume of the interior candle space is necessarily exchanged or flushed. Furthermore, the gap also makes it possible during the filling of a filter that the filter candle can be vented. Formation of air pockets in the interior filter candle space can consequently be prevented. A pressure surge, for example a back surge of water, during the backflushing is consequently not damped by trapped air bubbles, such that more dependable blasting off of the filter cake becomes possible.

The distance from the terminating piece within which the lower end portion of the interior candle space is located may be less than 80%, preferably less than 50%, particularly preferably less than 30%, of the outside candle diameter.

The filter candle may be assigned a connection piece for connecting the filter candle to a separating wall of a precoat candle filter, the gap also being formed between the immersion tube and the connection piece when the filter candle is used as intended. If the connection piece is assigned directly to the filter candle, the fitting of the filter candle in a precoat candle filter is made much easier. It goes without saying here that the connection piece must be formed in such a way that it can be arranged in a separating wall of a precoat candle filter, and consequently makes the solid connection of the filter candle to the separating wall possible.

The gap between the end piece or the connection piece and the immersion tube may be formed peripherally around the immersion tube. A peripheral gap ensures uniform venting or flowing in of a flushing medium. In this case, the immersion tube may be arranged concentrically in the end piece or in the connection piece and in the interior candle space, such that the flow movements of the corresponding fluids are even more uniform.

In the case of typical outside candle diameters of 25 mm to 32.5 mm, the gap may have a size of between 0.2 mm and 10.0 mm, preferably between 0.5 mm and 5.0 mm, particularly preferably between 1.0 mm and 3.0 mm. The gap must be dimensioned to be of such a size that optimal backflushing is made possible and a sufficiently great amount of backflushing medium to allow the filter cake to be detached can be introduced. On the other hand, the dimension of the gap is limited by the inside diameter of the end piece or of the connection piece and the outside diameter of the immersion tube. The end piece, the connection piece and the immersion tube must have certain minimum dimensions, in particular certain minimum wall thicknesses, on account of stability and/or flow velocities and/or pressure loads.

The immersion tube may have at least one diameter-increasing baffle ring on its outer side. This baffle ring brings about a deflection of the backflushing medium toward the inner wall of the interior candle space during the backflushing through the gap, which is particularly conducive to the detachment of the filter cake.

The baffle ring may have an outside diameter that is at least 1.0 mm, preferably at least 2.0 mm, particularly preferably at least 4.0 mm, greater than the outside diameter of the immersion tube in the interior candle space. Depending on the design of the form of the change in diameter and the dimension thereof, this can be conducive to the effect of easier detachment of the filter cake. The outer surface of the baffle ring may for example be of a cylindrical form with sharp edges, such that the abrupt change in diameter brings about the deflection of the backflushing medium. The outer surface may, however, also be at least partially of a conical design, with a straight, concave or convex cone surface, in order to be conducive to the deflection. In terms of flow, other designs are also conceivable, for example the form of a torus with a circular or elliptical cross section. However, for easy fitting and/or exchangeability of the immersion tube, it must be ensured that the baffle ring should allow itself to be pushed through the end piece and the connection piece.

The baffle ring may be arranged on the immersion tube in such a way that, when used as intended, it is arranged in the interior candle space in an upper end region near the upper end of the candle wall. In this case, “near the upper end” is understood as meaning that the baffle ring is located at a distance of between 1.0 mm and 100 mm, preferably between 5.0 mm and 50 mm, particularly preferably between 10 and 20 mm, from where the immersion tube emerges from the end piece. The arrangement of the baffle ring in the upper end region has the effect that, during the backflushing through the gap, the flushing medium is deflected toward the candle wall in the upper end region. If there is sufficient pressure of the flushing fluid, the filter cake is consequently preferably detached in the upper end region. Flushing medium breaking through can consequently flush away the filter cake outside the candle wall from the top downward.

When used as intended, for example in the case of precoat filtration with filter candles in suspended installation, the immersion tube may have at its upper end a head with a fastening means for fastening to an immersion tube plate of a precoat candle filter. Such an immersion tube plate may for example be arranged at a distance from a separating plate for the fastening of the filter candles. In this case, the immersion tube plate is arranged on the side of separating plate that is opposite from the unfiltrate space. Thus, a flushing space is formed between the immersion tube plate and the separating plate. Known fastening means, such as for example a bayonet closure, a screw closure, a press fit, a snap connection, etc., come into consideration as fastening means.

The fastening means may be an external thread. Correspondingly, the immersion tube plate must have a corresponding opening with an internal thread. It has been found that such screw connections are easy to maintain and very reliable. Furthermore, a sealing means, for example an O-ring, can be pressed in a finely measured manner between the head of the immersion tube and the immersion tube plate, such that a satisfactory seal is ensured. It goes without saying that, in the case of seals, corresponding receptacles and/or stops are provided on the head or on the immersion tube plate.

A precoat candle filter according to the invention comprises in a known way a filter vessel with a separating wall, which separates the filter vessel into an unfiltrate space and a filtrate space. A multiplicity of filter candles, in particular as described above, are fastened to the separating wall and extend from the separating wall into the unfiltrate space. Arranged between the filtrate space and the separating wall is an immersion tube plate, to which the immersion tubes are fastened. The immersion tube plate also separates a flushing chamber, which is fluidically connected to an interior candle space of the filter candles, from the filtrate space. The flushing chamber is consequently formed between the separating wall and the immersion tube plate. This flushing chamber allows for example a backflushing of the filter candle without the filtrate space likewise being filled with flushing medium. A flushing chamber is understood as meaning any volume within the filter vessel which, when the precoat candle filter is used as intended, is separated by the filter candles from the unfiltrate space and is connected or can be connected to the filtrate space by an interior candle space of the filter candles. When used as intended, the flushing chamber is preferably arranged above the filter candles and connected to the interior candle space in such a way that the latter can be vented.

Correspondingly, the flushing chamber may have a connection for venting and/or flushing. The individual filter candles can be vented by way of the flushing chamber and this connection, which is advantageous in particular during filling.

A further aspect of the present invention relates to the use of a filter candle as described above in a precoat candle filter as described above.

A method according to the invention for upgrading or retrofitting a filter system with a precoat candle filter comprises the following steps in any desired sequence:

replacing conventional filter candles with filter candles as described above or retrofitting conventional filter candles each with an immersion tube, such that filter candles as described above are formed,

constructing a flushing chamber, in particular with an immersion tube plate adjoining a conventional separating wall in at least one precoat candle filter,

connecting the flushing chamber to the interior candle space, in particular by connecting the gap to the flushing chamber,

connecting the immersion tubes of the filter candles to the filtrate space.

Such a simple method allows an existing system with conventional precoat filters to be easily modified and equipped with the filter candles or immersion tubes according to the invention that are described above. A system modified in this way allows a significant reduction in the amounts that are mixed during first-runnings separation and last-runnings separation.

In this case, first-runnings separation is understood as meaning the phase after applying a first precoat layer, for example with water, and subsequently feeding the product to be filtered, for example beer, up to achieving a predetermined concentration of the filtrate.

Last-runnings separation is understood as meaning the phase at the end of the filtration, when the product to be filtered, for example beer, is displaced before the discharge of the filter cake with the aid of another medium, for example with CO₂ (carbon dioxide) or in the case of the traditional method with water.

A method according to the invention for operating a precoat candle filter as described above, the filtrate space, the unfiltrate space and the flushing chamber each having at least one connection for venting, emptying and/or filling, comprises at least one of the following steps in any desired sequence and/or combination:

filling the precoat candle filter with unfiltrate or water and venting the precoat candle filter, the connections of the unfiltrate space and of the flushing chamber being permanently or at least temporarily open for the purpose of venting,

emptying the precoat candle filter, the connection of the flushing chamber being closed and the connections of the filtrate space and of the unfiltrate space being open, and a gas being introduced into the unfiltrate space through the connection of the unfiltrate space,

drying and/or blowing out the filter cake and/or displacing a filtrate from the interior candle space and/or from the filtrate space, the connection of the flushing chamber being closed, and a gas being introduced into the unfiltrate space through the connection of the unfiltrate space when the precoat candle filter has been completely or partially emptied, the gas leaving again through the filtrate space,

flushing out the interior candle spaces, the connection of the unfiltrate space being closed and the connections of the flushing chamber and of the filtrate space being open, and a flushing medium being introduced through the connection of the flushing chamber or through the connection of the filtrate space,

discarding the filter cake, the connections of the filtrate space and of the unfiltrate space being closed and the connection of the flushing chamber and an opening in the unfiltrate space to the sludge discharge being open, and a flushing medium, for example water, being introduced into the flushing chamber.

For discarding the filter cake, an abrupt increase in pressure may be applied to the flushing medium. Making the increase in pressure take place abruptly is conducive to the detachment of the filter cake. In particular when introducing the flushing medium through the gap between the end piece or the connection piece and the immersion tube, the baffle ring has a further conducive effect on detachment of the filter cake.

A cleaning device according to the invention for a precoat candle filter has a water connection, one or more spray nozzles for introducing a cleaning agent into an unfiltrate space and a system of pipes for connecting the spray nozzles to the water connection. The cleaning device is attached or can be attached to a separating plate for separating the unfiltrate space from a filtrate space. In this case, the spray nozzle is designed in such a way that a fluid can be drawn off from an unfiltrate space of a precoat candle filter through the spray nozzle. It goes without saying that the water connection is not restricted to the connecting of water but that any kinds of cleaning fluids can be introduced into the unfiltrate space by way of this water connection. The one or more spray nozzles are preferably arranged on the separating plate in such a way that they can spray out the entire unfiltrate space uniformly and in particular can wash off any remains of discarded filter cake from the filter candles. For this purpose, when used as intended, the cleaning device and the spray nozzles are arranged in the upper end of the unfiltrate space and are fastened to the separating plate. Since the spray nozzle allows not only a cleaning agent to be introduced but also a fluid to be drawn off from the unfiltrate space, a change of phase can be carried out in the unfiltrate space very easily and efficiently. Thus, an old phase can be drawn off from the filtrate space in a way that is as free from turbulence as possible, without any load being imposed on the filter candles. Mixing of the old phase with a new phase in the unfiltrate space can be reduced or prevented entirely. Furthermore, the multiplicity of spray nozzles through which the fluid is drawn off means that an excessive flow does not build up, such that the filter cakes of the individual candle filters are not impaired.

The spray nozzle may have a baffle plate for uniformly distributing an inflowing cleaning agent in the unfiltrate space. Such a baffle plate makes it possible in an easy way to distribute in all directions the cleaning agent sprayed in through the spray nozzle. If the baffle plate is concavely formed, an impinging jet is even deflected as far as the separating plate and can also clean that. Such a baffle plate may be fastened to a spacer in front of the mouth of the spray nozzle.

The spray nozzle may be designed in such a way that a flow resistance in the direction of the unfiltrate space is greater than a flow resistance when a fluid is drawn off from the unfiltrate space. Consequently, when cleaning, a cleaning agent can be sprayed into the unfiltrate space at high pressure, while the drawing off of a fluid from the unfiltrate space takes place without any significant pressure loss.

To increase the spraying-in pressure, the spray nozzle may have in the direction of the unfiltrate space a check valve, which hinders the introduction of a cleaning agent, for example, into the unfiltrate space. This check valve may allow flow to pass through by means of at least one bypass opening. With the number, size and design of the bypass openings, both the pressure and the form of the jet for the spraying in can be influenced. For example, a check valve may hold a ball within a valve chamber. Such a ball is pressed in the direction of the unfiltrate space into a valve seat by the flow of the cleaning agent, and consequently closes a mouth to the unfiltrate space. At least one bore, which opens out into the valve chamber alongside the valve seat, is conceivable as a bypass opening.

A precoat candle filter according to the invention, in particular as described above, with an unfiltrate space, a filtrate space and a separating wall, comprises a cleaning device as described above. In this case, the cleaning device is arranged in the unfiltrate space, on the separating plate. Such a precoat candle filter allows the cleaning device to be used both for cleaning and for drawing off unfiltrate from the unfiltrate space.

In the case of a method according to the invention for changing phases in a precoat candle filter with filter candles, in particular in a precoat candle filter as described above, a next phase being introduced into the unfiltrate space, only part of the phase is drawn off through the filter candles and part of the phase is drawn off directly from the unfiltrate space by a cleaning device and/or by a venting connection of the unfiltrate space until a predefined phase concentration in the filtrate is reached. The cleaning device may in this case be designed as described above. A change of phase is necessary for example when precoating the filter candles and subsequently carrying out filtration. Thus, for example, a filter aid, for example diatomaceous earth, may be precoated by means of water. As soon as the filter candle has built up a sufficiently great filter cake, a change of phase takes place, for example to beer. As long as there is still water in the unfiltrate space and in the filter candles, the beer to be filtered is mixed with this water. This mixed phase cannot continue to be used as beer and represents an actual loss. The fact that, when there is a change of phase, now only a small part is drawn off through the filter candles, while the greater part is drawn off directly from the unfiltrate space, means that there is only a very small mixed phase that cannot be used. If turbulences can be avoided when drawing off the phase directly from the unfiltrate space, the separation between water and beer can take place relatively easily, such that here too the loss of beer can be kept small.

Between 50% and 99%, preferably between 65% and 95%, particularly preferably between 80% and 90%, of the phase can be drawn off directly from the unfiltrate space. Correspondingly, between 1% and 50%, preferably between 5% and 35%, particularly preferably between 10% and 20%, of the phase is drawn off through the filter candles. These are ratios that are preferably preset by corresponding pipe cross sections, such that it is possible to dispense entirely with the use of valves. It has been found that a certain flow through the filter candles is necessary in order to keep the filter cake stable on the filter candle. If there is too small a portion of flow through the filter candles, the filter cake may become detached, such that renewed precoating has to be performed.

The invention is explained in more detail below on the basis of figures, which merely represent exemplary embodiments and in which:

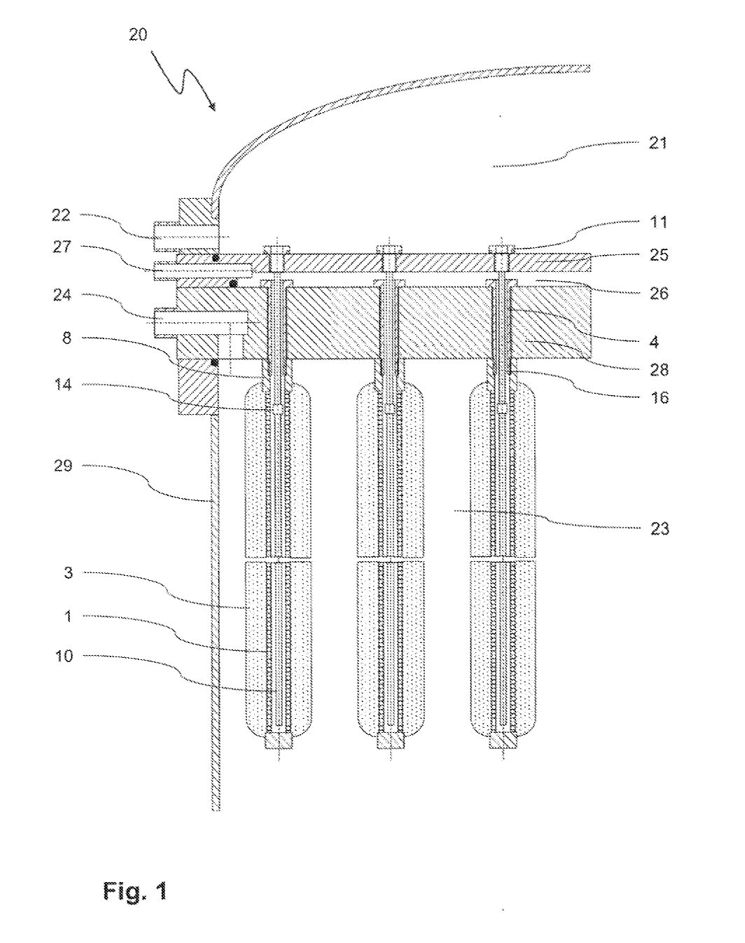

FIG. 1 shows a detail of a precoat candle filter according to the invention,

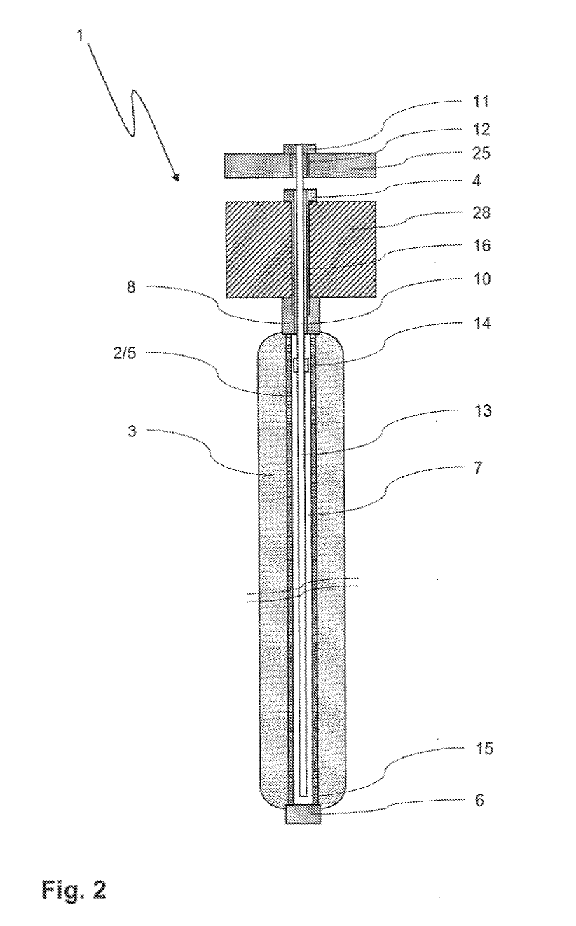

FIG. 2 shows a filter candle according to the invention,

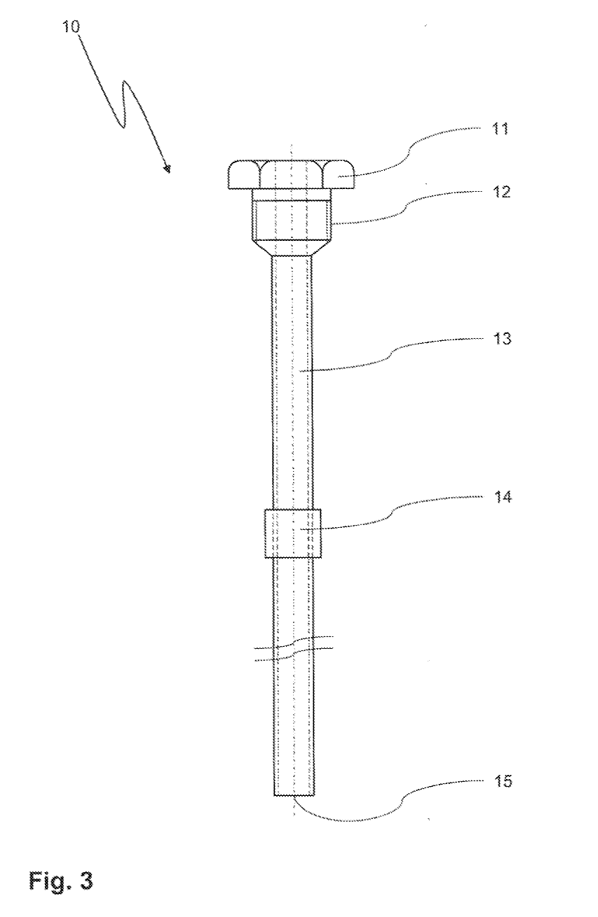

FIG. 3 shows a detailed drawing of an immersion tube,

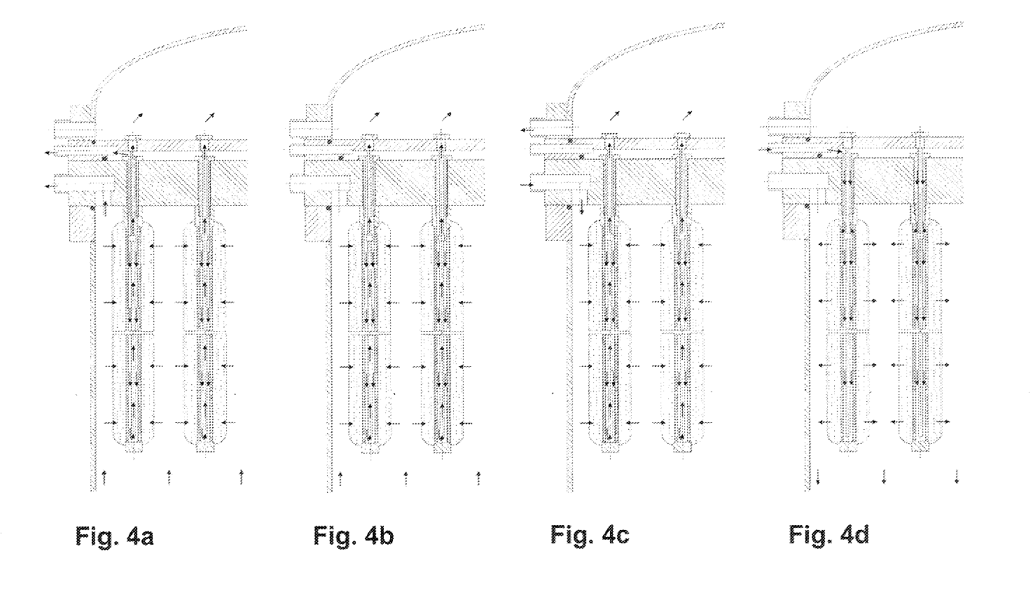

FIG. 4a shows a representation of the directions of flow of a medium in the precoat candle filter according to FIG. 1 during filling,

FIG. 4b shows a representation of the directions of flow of a medium in the precoat candle filter according to FIG. 1 during filtering,

FIG. 4c shows a representation of the directions of flow of a medium in the precoat candle filter according to FIG. 1 during emptying,

FIG. 4d shows a representation of the directions of flow of a medium in the precoat candle filter according to FIG. 1 during discarding of a filter cake,

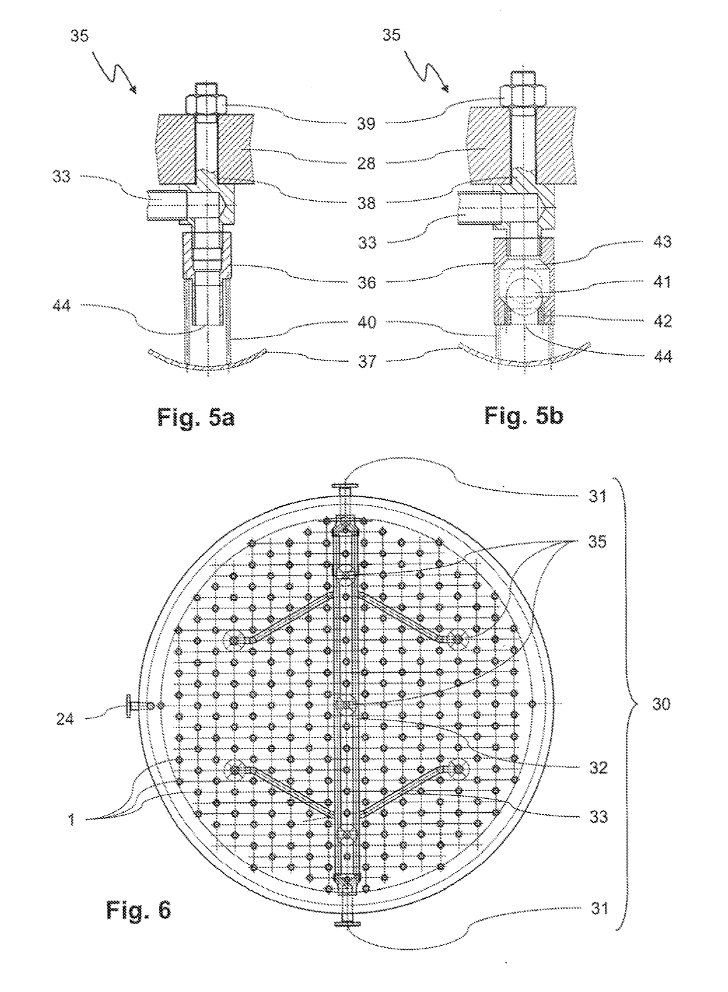

FIG. 5a shows a spray nozzle for flushing out the unfiltrate space,

FIG. 5b shows an alternative spray nozzle for flushing out the unfiltrate space, and

FIG. 6 shows a view from the unfiltrate space of a separating wall of a precoat candle filter.

FIG. 1 shows a detail of a precoat candle filter 20. The precoat candle filter 20 consists substantially of a filter vessel 29, which forms a casing of the precoat candle filter 20. A separating wall 28 separates an unfiltrate space 23 from a filtrate space 21. In addition to this conventional separating wall 28, an immersion tube plate 25 is also provided, such that an additional space, to be specific a flushing chamber 26, is separated off. Each individual space, the filtrate space 21, the unfiltrate space 23 and the flushing chamber 26, is provided with a connection 22, 24, 27 for venting, emptying and/or filling. In the separating wall 28, the filter candles 1 are each fixed in a customary manner with a connection piece 4. The connection piece 4 is in this case formed as a tube, which can be inserted in the separating wall 28 and connected to an upper end piece 8 of the filter candle 1. The connection piece 4 may also be formed in one piece with the separating wall 28. Through this connection piece 4 and the end piece 8 there leads in each case an immersion tube 10, which is fastened to the immersion tube plate 25 and reaches as far as the lowermost point of the filter candle 1. At its upper end, the immersion tube 10 has a head 11, by means of which the immersion tube 10 is fastened in the immersion tube plate 25. Between the immersion tube 10 and the end piece 8 or the connection piece 4 there is a gap 16, which may be used for example for backflushing or for venting the filter candle 1. The immersion tube 10 also has a baffle ring 14, which in the case of backflushing deflects a flushing medium toward the inner wall of the filter candle 1 and correspondingly detaches a built-up filter cake 3.

In FIG. 2, a filter candle 1 according to the invention is represented. The filter candle 1 consists substantially of a candle wall 5, which in the filter candle represented is a split tube 2. This candle wall 5 is closed at its underside by a terminating piece 6, such that unfiltrate cannot penetrate into the interior candle space 7, but can only penetrate through the precoat layer 3 and the candle wall 5. Attached at the opposite end is a tubular or annular end piece 8, by means of which the filter candle 1 can be fastened to a connection piece 4 in a separating wall 28 of a precoat candle filter 20 (see FIG. 1) and which forms a feedthrough to a chamber lying above the separating wall 28. The inside diameter of the connection piece 4 is in this case preferably dimensioned to be the same size as the inside diameter of the end piece 8. Furthermore, the filter candle 1 has an immersion tube 10, which protrudes from outside the connection piece 4 through the connection piece 4 and through the end piece 8 into the interior candle space 7 and has an opening 15 in the lower region of the filter candle 1, that is to say near the terminating piece 6. Above this opening 15, the immersion tube has a closed wall. The immersion tube 10 has a continuous bore 13 over its entire length. The immersion tube 10 is in this case dimensioned such that a gap 16 is formed peripherally between the immersion tube 10 and the connection piece 4 and between it and the end piece 8. At the end opposite from the opening 15, the immersion tube 10 has a head 11, which has an external thread 12. With this external thread 12, the immersion tube 10 can be screwed into an immersion tube plate 25 of a precoat candle filter 20 that is provided with a corresponding internal thread (see FIG. 1). A gap is likewise formed between the immersion tube 10 and the candle wall 5.

Thus, when the filter candle 1 is intended to be cleaned or backflushed, the space between the immersion tube plate 25 and the separating wall 28 can be filled with a flushing medium. The flushing medium will flow into the interior candle space 7 through the gap 16 between the immersion tube 10 and the end piece 8 or the connection piece 4. On the immersion tube 10, a baffle ring 14, which locally increases the outside diameter of the immersion tube, brings about a deflection of the flushing medium, such that it is deflected toward the inner side of the candle wall 5. With sufficiently great pressure of the flushing medium, a filter cake 3, which has formed on the outer side of the candle wall 5 during the filtration, is consequently detached. The fact that the baffle ring 14 follows the connection piece 4 or the end plate 8 at a distance of about 20 mm has the effect that the flushing medium is deflected radially outward in this region, such that the filter cake 3 is detached at its uppermost end. A liquid flushing medium will correspondingly emerge from the filter candle 1 through the opening in the split tube 2 that has thereby been cleared and will flush away the filter cake 3 from the outside of the split tube 2.

FIG. 3 shows a detailed drawing of an immersion tube 10. As already mentioned, the immersion tube 10 consists substantially of a tube with a continuous bore 13. At its lower end in the representation, the tube has an opening 15. The end of the immersion tube 10 that is opposite from the opening 15 is provided with a head 11. This head 11 has on the one hand a thread 12, which allows fastening in an immersion tube plate 25 (see FIGS. 1 and 2). Furthermore, the head 11 has an external hexagon, which allows screwing in with a suitable tool. The head 11 of the immersion tube 10 may also be formed differently, and in particular have other fastening means. The outside diameter of the immersion tube 10 is locally increased by a baffle ring 14. This baffle ring is in this case arranged such that, when the immersion tube 10 is installed in the interior candle space 7 as intended, it is located directly below the connection piece 4 or the end piece 8 (see FIG. 2). The baffle ring 14 may for example be a cylindrical ring that is pushed onto the immersion tube 10 and for example soldered or welded on. It goes without saying that other forms of production are also conceivable. The immersion tube 10 may be designed in one piece or be made up of multiple parts, for example of a tube and a head 11. The immersion tube 10 preferably consists of high-grade steel. However, other materials are also conceivable, for example plastic.

In FIGS. 4a to 4d, the directions of flow of various media in a precoat filter in different states of use are represented by arrows. In this case, FIG. 4a shows the situation during filling and emptying, FIG. 4b the situation during filtering, FIG. 4c the situation during emptying and drying/blowing out of the filter cake and displacing of filtrate and FIG. 4d the situation during discarding of the filter cake.

FIG. 5a shows a first embodiment of a spray nozzle 35 for flushing out the unfiltrate space 23 (see FIG. 1). The spray nozzle 35 has a fastening screw 38, by means of which the spray nozzle 35 can be fastened to a separating wall 28 of a precoat candle filter. For this purpose, the separating wall 28 has for example a bore, which receives the fastening screw 38 and to the end of which the fastening screw 38 can be fixed with a fastening nut 39. Furthermore, the spray nozzle 35 has a spray chamber 36, which can be supplied with cleaning agent by a line 33. A mouth 44 of the spray nozzle 35 is directed toward a baffle plate 37, which is fastened to a spacer 40 on the spray head 36. The baffle plate 37 is concavely designed. A jet of cleaning agent is consequently deflected by the baffle plate 37 and distributed on all sides in the unfiltrate space. The concave form of the baffle plate 37 has the effect that the cleaning agent is even deflected as far as the separating wall 28.

In FIG. 5b, an alternative embodiment of a spray nozzle 35 for flushing out the unfiltrate space 23 (see FIG. 1) is represented. The spray nozzle 35 is substantially identical to the spray nozzle according to FIG. 5a, but the spray head 36 has a check valve with a valve ball 41 and multiple bypass bores 42. When a cleaning fluid is sprayed in, the valve ball 41 closes the mouth 44 of the valve chamber 43. However, arranged alongside this mouth 44 are bypass bores 42, which altogether have a smaller cross section than the mouth 44, and consequently allow an increased spraying pressure. When the spray nozzle 35 is used for drawing off a liquid from the unfiltrate space, the valve ball 41 clears the mouth 44, so that the fluid can be drawn off from the unfiltrate space as far as possible without any loss of pressure.

FIG. 6 shows a view from the unfiltrate space 23 of a separating wall 28 (for both see FIG. 1) of a precoat candle filter. The cleaning device 30 can be seen, comprising a system of pipes with a water connection 31, a distribution pipe 32, lines 33 and spray nozzles 35. A cleaning agent is introduced by way of the two water connections 31 and distributed between the two distribution pipes 32. From the distribution pipes 32, lines 33 branch off to the individual spray nozzles 35, which spray the cleaning agent uniformly into the unfiltrate space. A connection 24 of the unfiltrate space, which can be used for example for venting the unfiltrate space, can also be seen. Likewise represented are the filter candles 1, which are arranged in a regular pattern. The spray nozzles 35 are in this case respectively arranged instead of a filter candle 1 in order to ensure an optimum distribution of the cleaning agent. Alternatively, the spray nozzles 35 may also be arranged between the filter candles 1.

1-21. (canceled)

22. A filter candle for precoat filtration, the filter candle being intended for suspended installation, having an end piece for the connection of the filter candle to a separating wall of a precoat candle filter, a candle wall, which together with a precoated precoat layer forms the active filter layer, and a terminating piece for separating an interior candle space from an unfiltrate space, an immersion tube being arranged in the interior candle space and, when used as intended, reaching from outside the end piece through the separating wall and through the end piece into a lower end portion of the interior candle space, at least one opening being provided in the immersion tube within the lower end portion, wherein a gap is formed between the immersion tube and the end piece.

23. The filter candle as claimed in claim 22, wherein the filter candle is assigned a connection piece, the gap also being formed between the immersion tube and the connection piece.

24. The filter candle as claimed in claim 22, wherein the gap is formed peripherally around the immersion tube.

25. The filter candle as claimed in claim 22, wherein the gap has a size of between 0.2 mm and 10.0 mm.

26. The filter candle as claimed in claim 22, wherein the immersion tube has a diameter-increasing baffle ring on its outer side.

27. The filter candle as claimed in claim 26, wherein the baffle ring has an outside diameter that is at least 1.0 mm greater than an outside diameter of the immersion tube.

28. The filter candle as claimed in claim 26, wherein the baffle ring is arranged on the immersion tube in such a way that it is arranged in the interior candle space near the upper end of the candle wall.

29. The filter candle as claimed in claim 22, wherein the immersion tube has at its upper end a head with a fastening means for fastening to an immersion tube plate of a precoat candle filter.

30. The filter candle as claimed in claim 29, wherein the fastening means is an external thread.

31. A precoat candle filter having a filter vessel with a separating wall, which separates the filter vessel into an unfiltrate space and a filtrate space, and having a multiplicity of filter candles as claimed in claim 22, which are fastened to the separating wall and extend from the separating wall into the unfiltrate space, wherein arranged between the filtrate space and the separating wall is an immersion tube plate, to which the immersion tubes are fastened and which separates a flushing chamber, which is fluidically connected to an interior candle space of the filter candles, from the filtrate space.

32. The precoat candle filter as claimed in claim 31, wherein the flushing chamber has a connection for at least one of
venting, and
flushing.

33. A cleaning device for a precoat candle filter having a water connection, one or more spray nozzles for introducing a cleaning agent into an unfiltrate space and a system of pipes for connecting the spray nozzles to the water connection, the cleaning device being attached or able to be attached to a separating plate for separating the unfiltrate space from a filtrate space, wherein a fluid can be drawn off from an unfiltrate space of a precoat candle filter through the spray nozzles.

34. The cleaning device as claimed in claim 33, wherein the spray nozzle has a baffle plate for uniformly distributing an inflowing cleaning agent in the unfiltrate space.

35. The cleaning device as claimed in claim 33, wherein the spray nozzle is designed in such a way that a flow resistance in the direction of the unfiltrate space is greater than a flow resistance when a fluid is drawn off from the unfiltrate space.

36. The cleaning device as claimed in claim 35, wherein the spray nozzle has in the direction of the unfiltrate space a check valve, which allows flow to pass through by means of at least one bypass opening.
